(19) United States
(12) Patent Application Publication
(10) Pub. No.: US 2015/0088653 A1
(43) Pub. Date: Mar. 26, 2015

(54) MARKETING MANAGEMENT SYSTEM AND METHOD

(71) Applicant: Two West, Inc., Kansas City, MO (US)

(72) Inventors: Ethan J. Whitehill, Kansas City, MO (US); Thomas P. Tholen, Shawnee, KS (US); Mark A. Lopez, Kansas City, MO (US); Angela M. Potts, Kansas City, MO (US); Mohammad Omair Siddiqui, Overland Park, KS (US)

(21) Appl. No.: 14/494,339

(22) Filed: Sep. 23, 2014

Related U.S. Application Data
(60) Provisional application No. 61/881,344, filed on Sep. 23, 2013.

(51) Int. Cl. G06Q 30/02

(52) U.S. Cl. CPC G06Q 30/0269; G06Q 30/0261
USPC 705/14.58

(57) ABSTRACT

A demographic-based marketing system and related method of providing services, education, and tracking results for client business owners using a web-hosted remote server accessible by client computing devices. The system requests information from the clients and accesses multiple national databases to determine relevant customer demographic information which would direct the clients how to best advertise their products to increase local foot traffic to a physical retail location.

### CROSS-REFERENCE TO RELATED APPLICATIONS

This application claims priority in U.S. Provisional Patent Application No. 61/881,344, filed Sep. 23, 2013, which is incorporated herein by reference.

### BACKGROUND OF THE INVENTION

1. Field of the Invention

The present invention relates generally to a system and method for marketing management, and more specifically to an integrated software application for a marketing system and method of implementation.

2. Description of the Related Art

Marketing is a necessary tool for business. Strong competition and narrow profit margins means that those companies who are best able to identify their target demographics and to provide marketing and advertising directly to those potential consumers will be in the best position to succeed.

It is desirable to provide a logical addition to existing co-op advertising deployment systems, generally referred to in the industry as “Adbuilders.” These existing Adbuilders provide dealers with needed business tools and assets, but do not educate or otherwise supply basic information to the dealers as to how to best use those assets.

Heretofore there has not been available a system or method for the marketing management with the advantages and features of the present invention.

### SUMMARY OF THE INVENTION

The present invention generally provides a system and method for demographic-based marketing of business websites, and also provides a quick and simple tool for allowing users to quickly generate a new business website which incorporates the demographic-based marketing tools of the present invention.

The present invention incorporates a database of national data sources which will allow for targeting of advertising to specific clients. National databases could include Census data, other consumer demographic data, media consumption habits, or the like. Each end user of the present invention may require different data from different sources. All of this data will be filtered through zip codes and block codes, and that information will be provided to the end user through a software application accessible over a network, such as the internet.

### BRIEF DESCRIPTION OF THE DRAWINGS

The drawings constitute a part of this specification and include exemplary embodiments of the present invention illustrating various objects and features thereof

FIG. 1 is a diagram representing a method of practicing an embodiment of the present invention.

FIG. 2 is a diagrammatic representation of a user interface screen that is associated with one or more features of an embodiment of the present invention.

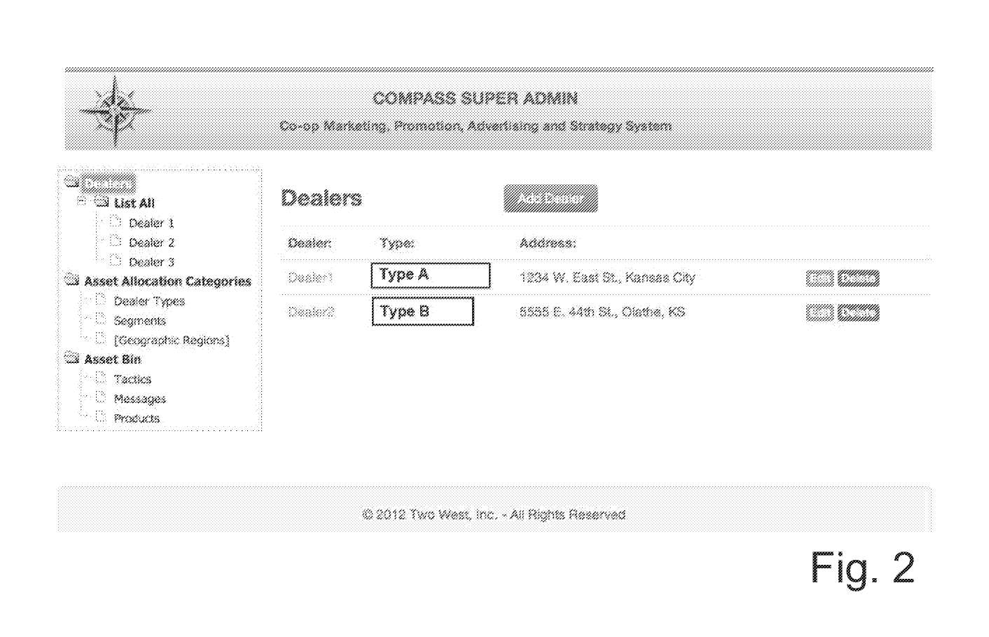

FIG. 3 is a diagrammatic representation of a user interface screen that is associated with one or more features of an embodiment of the present invention.

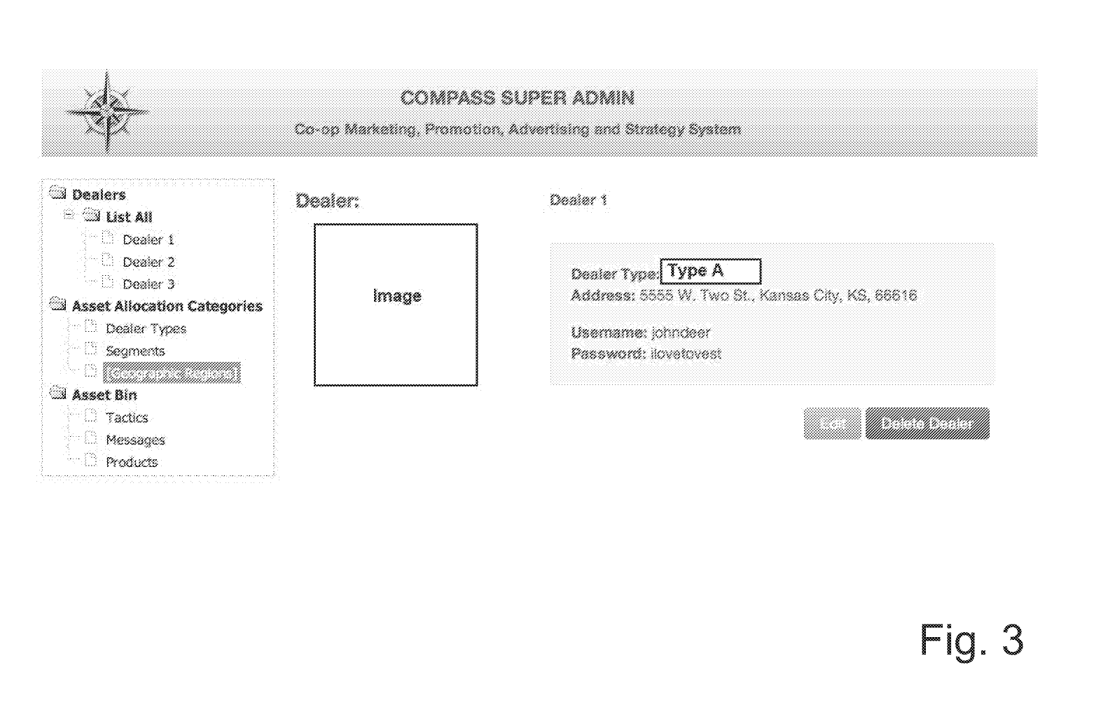

FIG. 4 is a diagrammatic representation of a user interface screen that is associated with one or more features of an embodiment of the present invention.

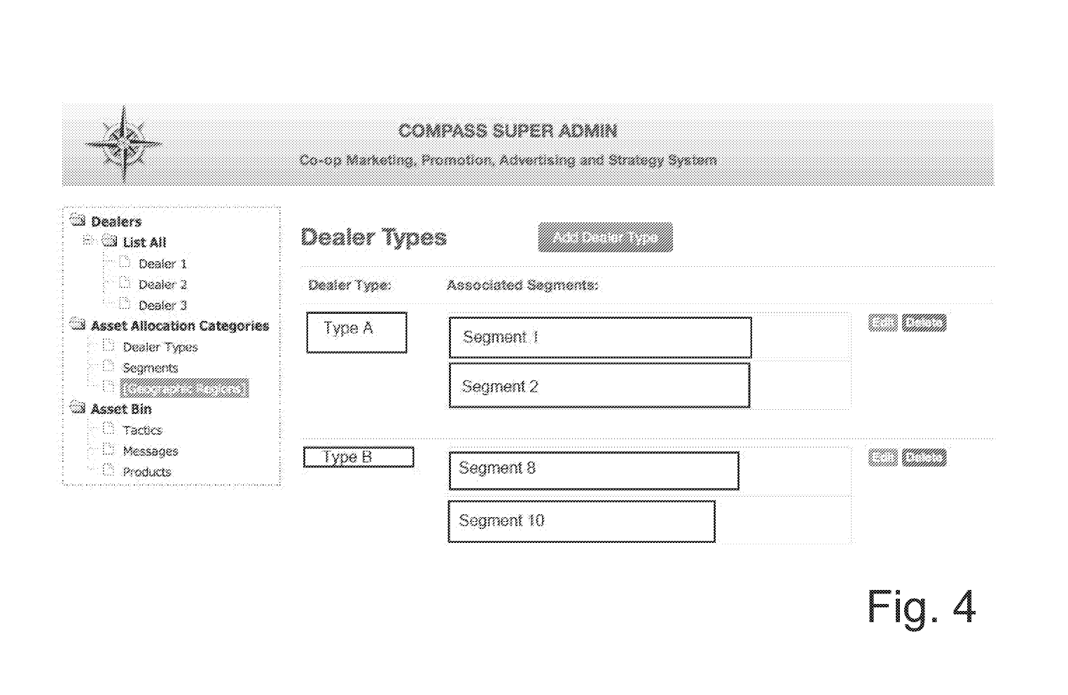

FIG. 5 is a diagrammatic representation of a user interface screen that is associated with one or more features of an embodiment of the present invention.

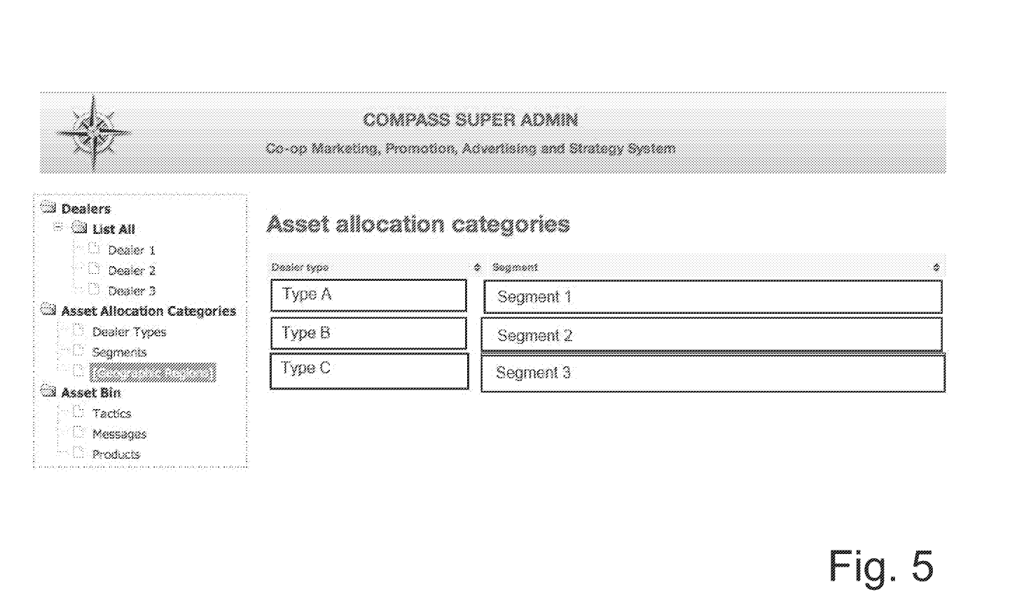

FIG. 6 is a diagrammatic representation of a user interface screen that is associated with one or more features of an embodiment of the present invention.

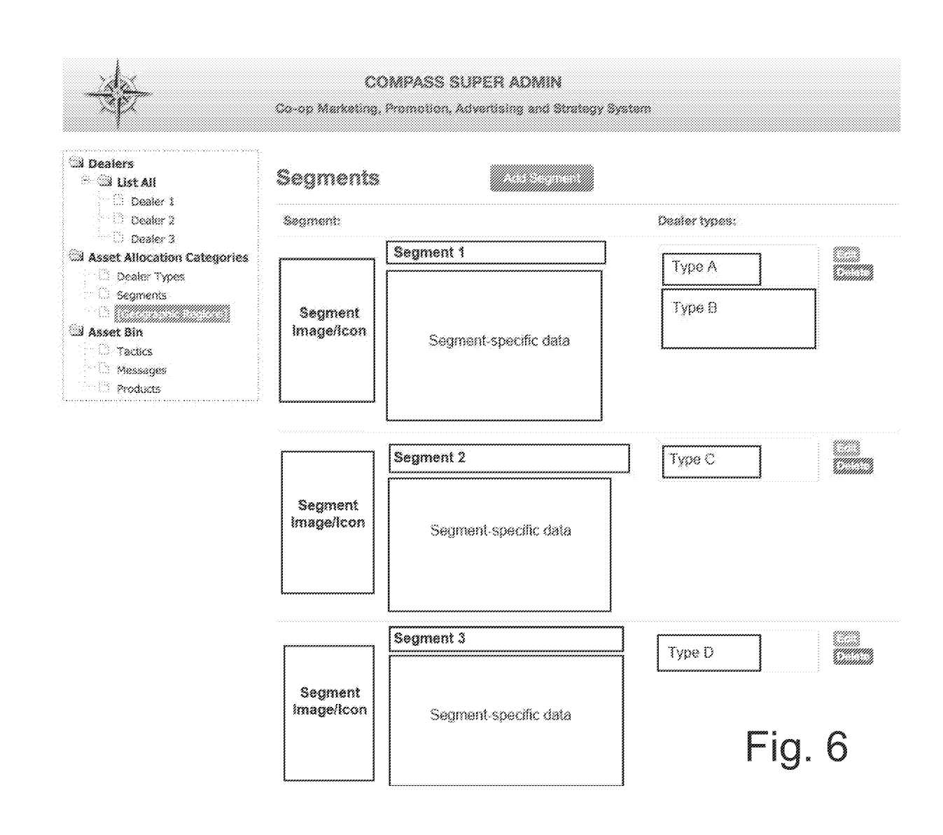

FIG. 7 is a diagrammatic representation of a user interface screen that is associated with one or more features of an embodiment of the present invention.

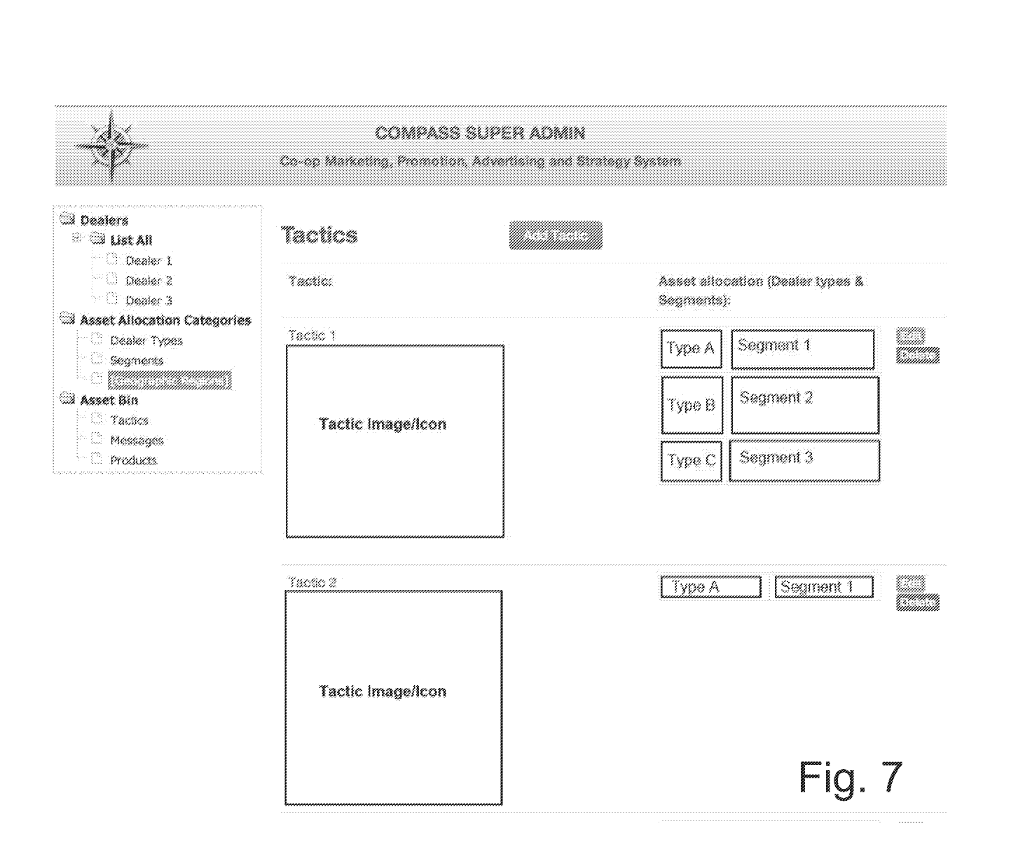

FIG. 8 is a diagrammatic representation of a user interface screen that is associated with one or more features of an embodiment of the present invention.

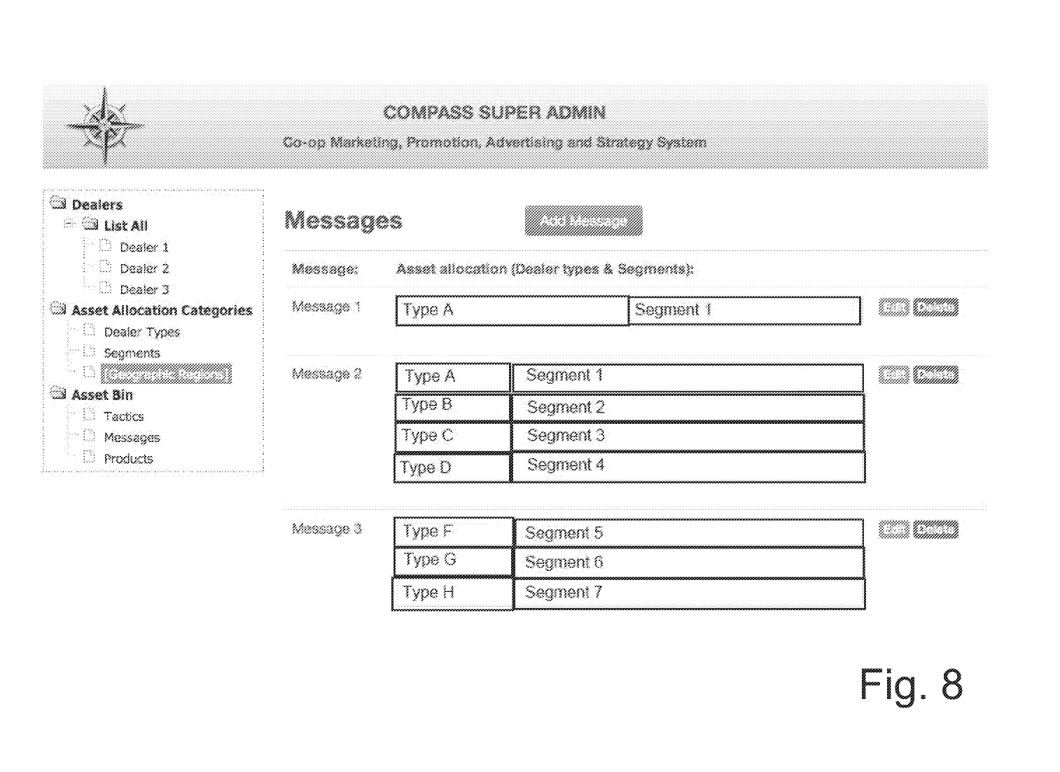

FIG. 9 is a diagrammatic representation of a user interface screen that is associated with one or more features of an embodiment of the present invention.

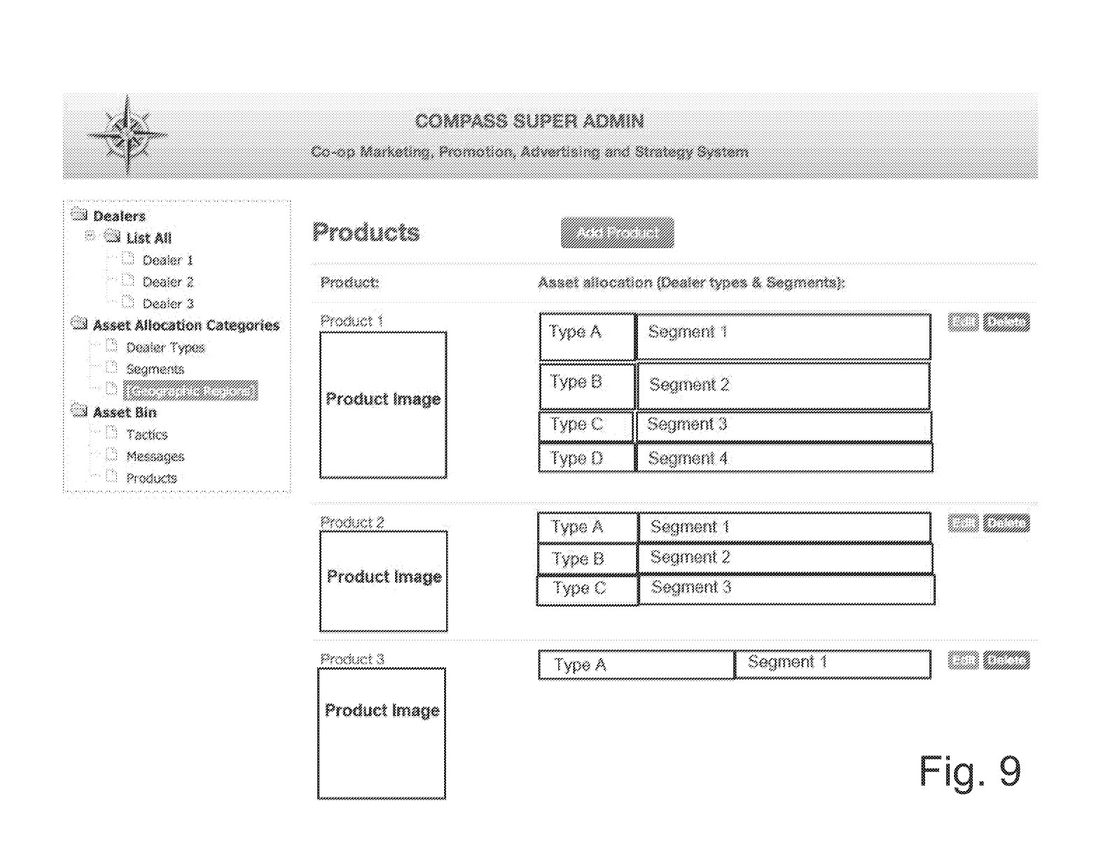

FIG. 10 is a diagram illustrating the relationship between various components of the present invention.

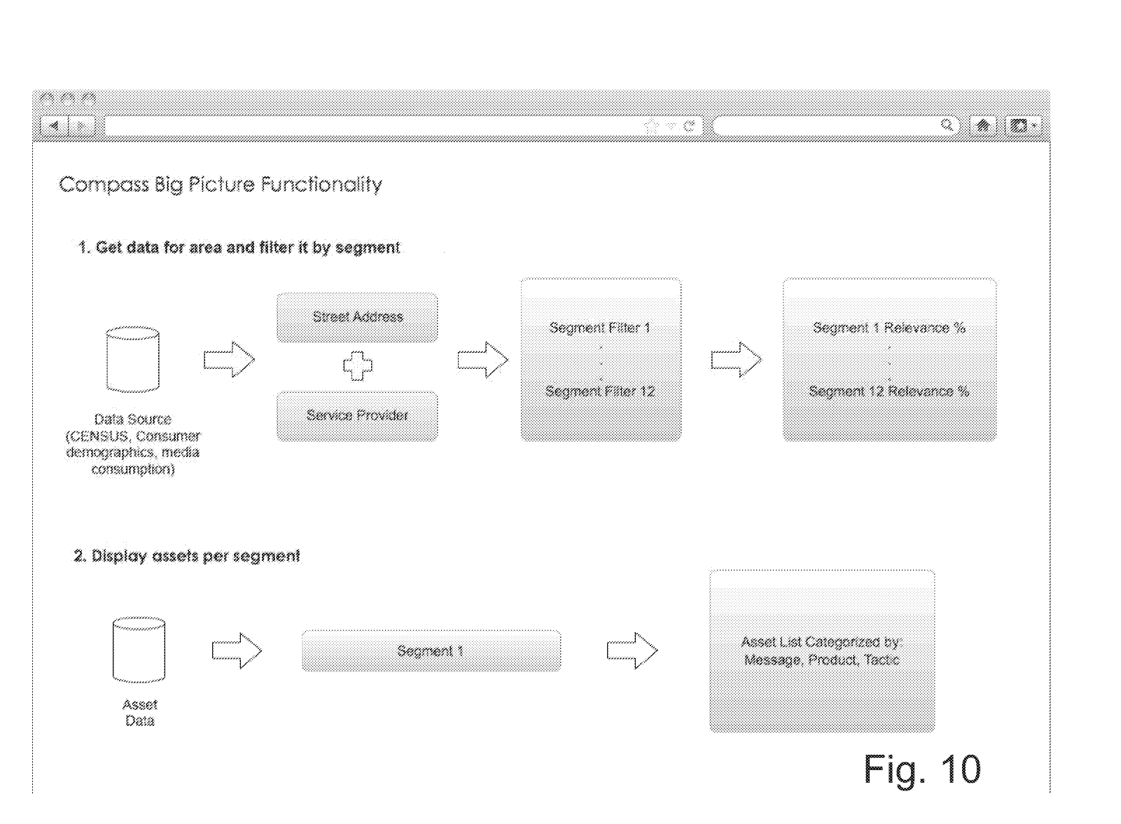

FIG. 11 is a diagram illustrating the organizational relationship of various components of the present invention.

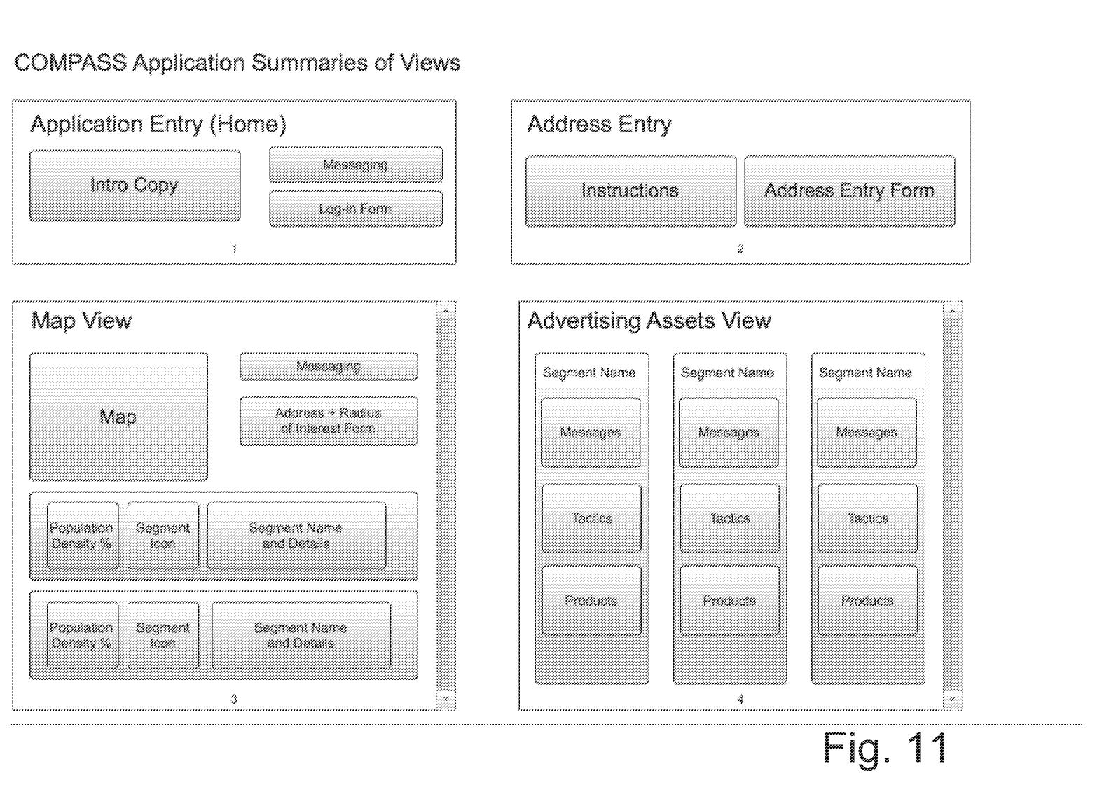

FIG. 12 is a diagrammatic representation of a user interface screen that is associated with one or more features of an embodiment of the present invention.

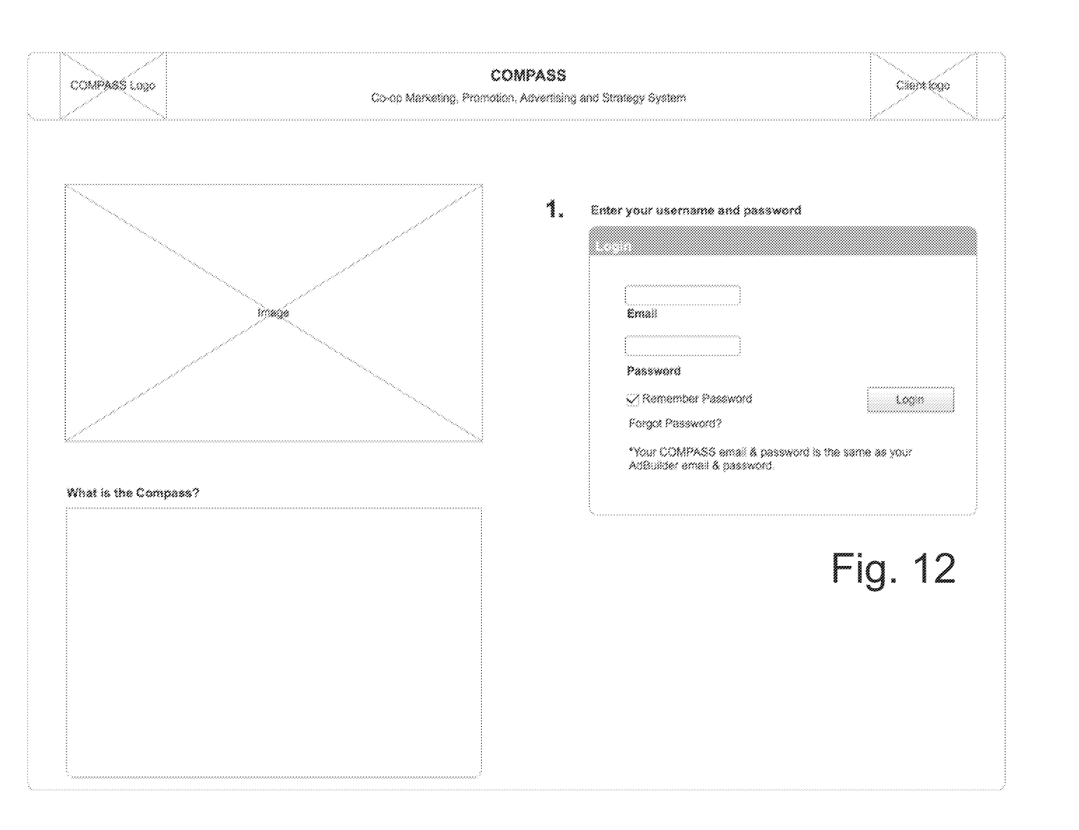

FIG. 13 is a diagrammatic representation of a user interface screen that is associated with one or more features of an embodiment of the present invention.

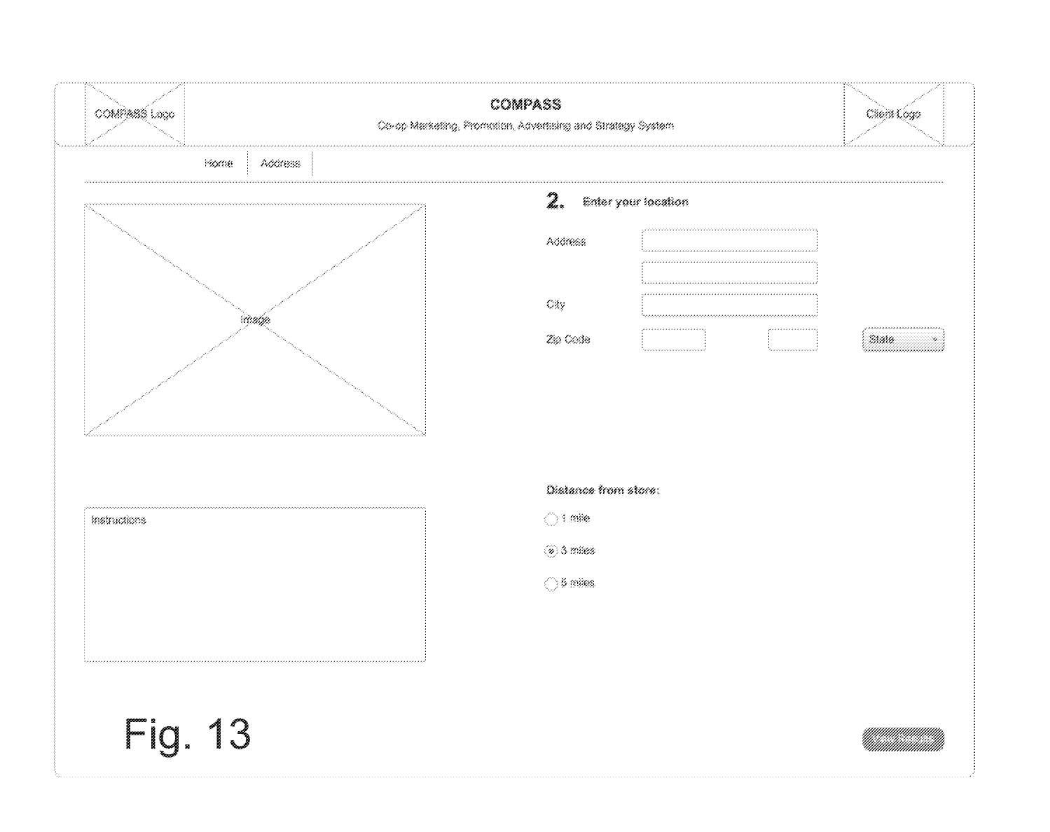

FIG. 14 is a diagrammatic representation of a user interface screen that is associated with one or more features of an embodiment of the present invention.

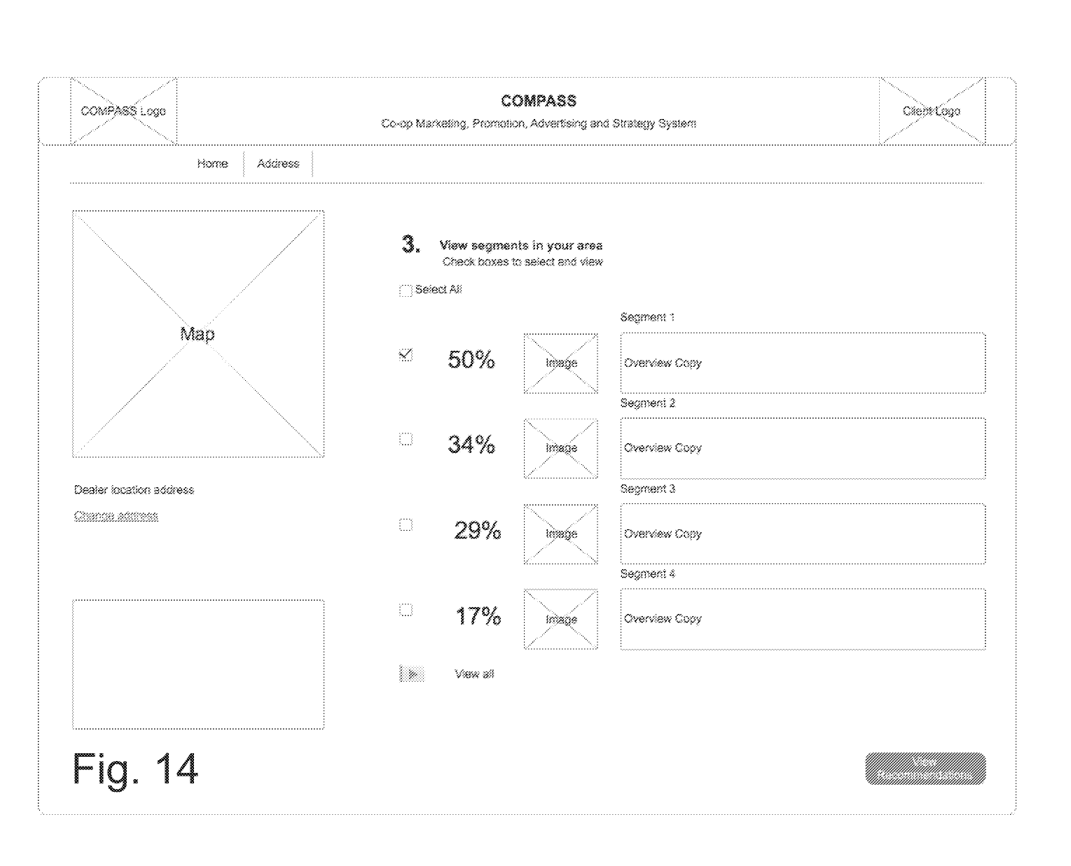

FIG. 15 is a diagrammatic representation of a user interface screen that is associated with one or more features of an embodiment of the present invention

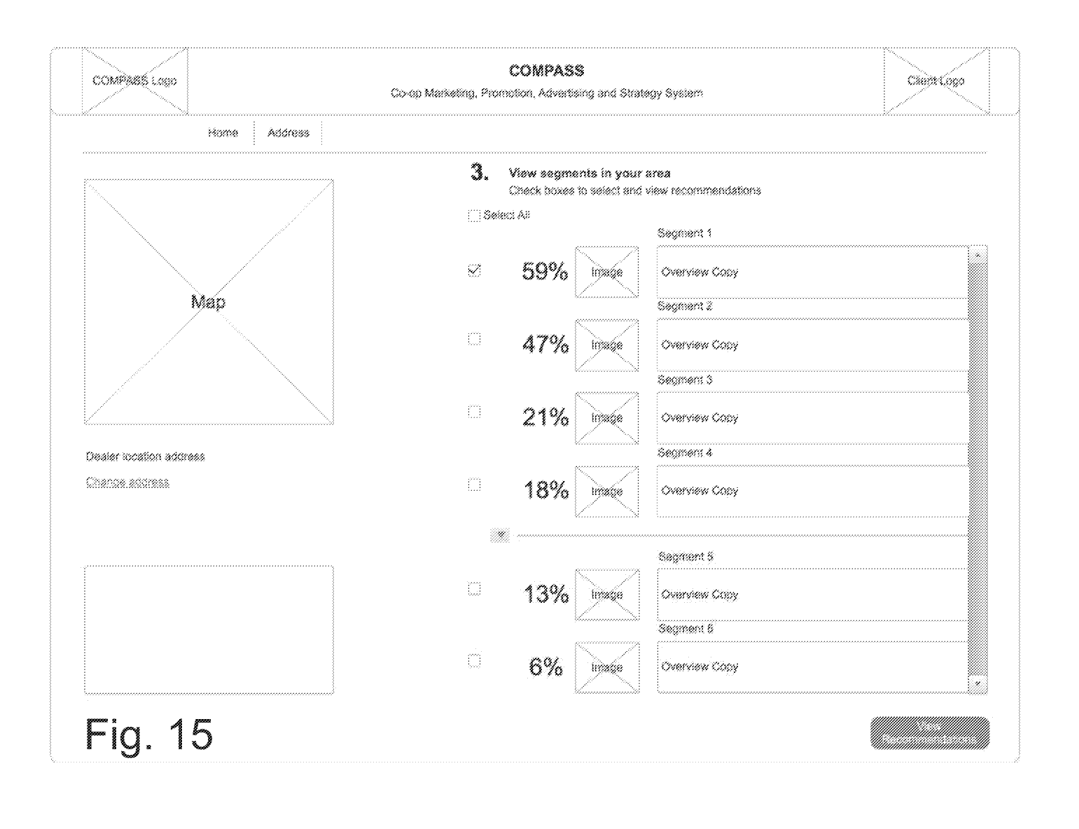

FIG. 16 is a diagrammatic representation of a user interface screen that is associated with one or more features of an embodiment of the present invention

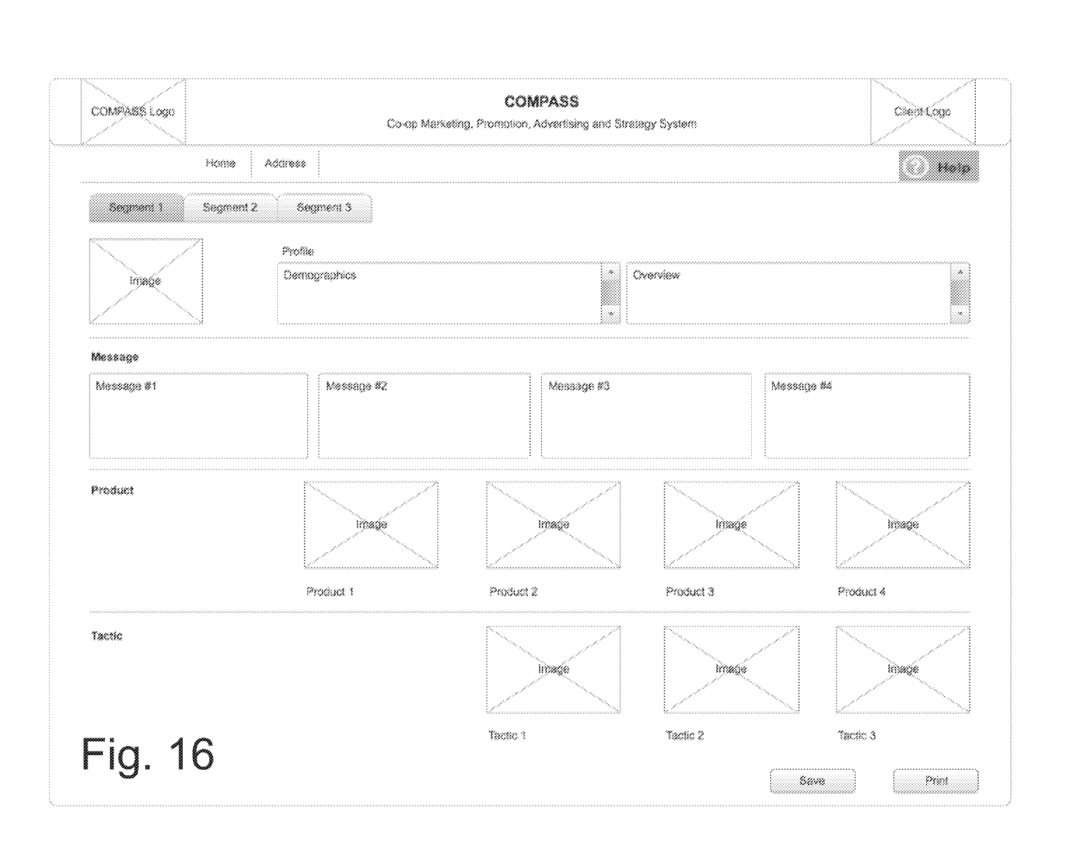

FIG. 17 is a diagrammatic representation of a series of steps involved in practicing an embodiment of the present invention.

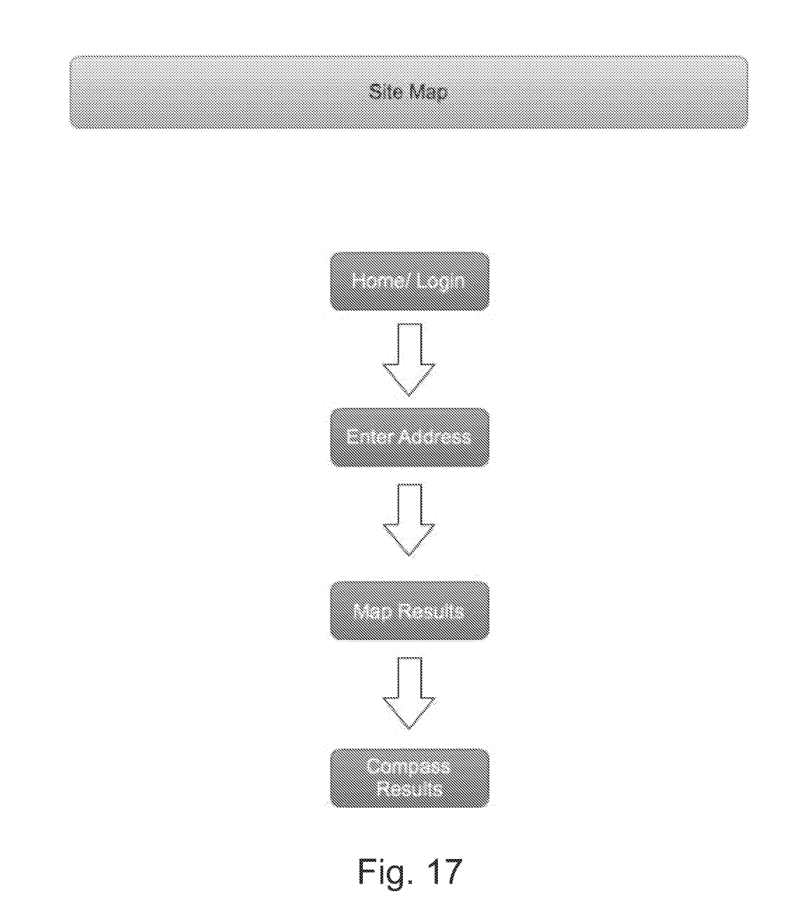

FIG. 18 is a schematic diagram showing the relationship between various technology elements as part of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Additional examples include computing devices such as a mobile smart device including a display device for viewing a typical web browser or user interface will be commonly referred to throughout the following description. The type of device, computer, display, or user interface may vary when practicing an embodiment of the present invention. A computing device could be represented by a desktop personal computer, a laptop computer, “smart” mobile phones, PDAs, tablets, or other handheld computing devices. Healthcare providers may include any person or entity within the healthcare field, from insurance providers, to pharmacists, to hospitals, to doctors, and more. Said terminology will include the words specifically mentioned, derivatives thereof and words of similar meaning.

### II. Preferred Embodiment Demographic-Based Marketing System

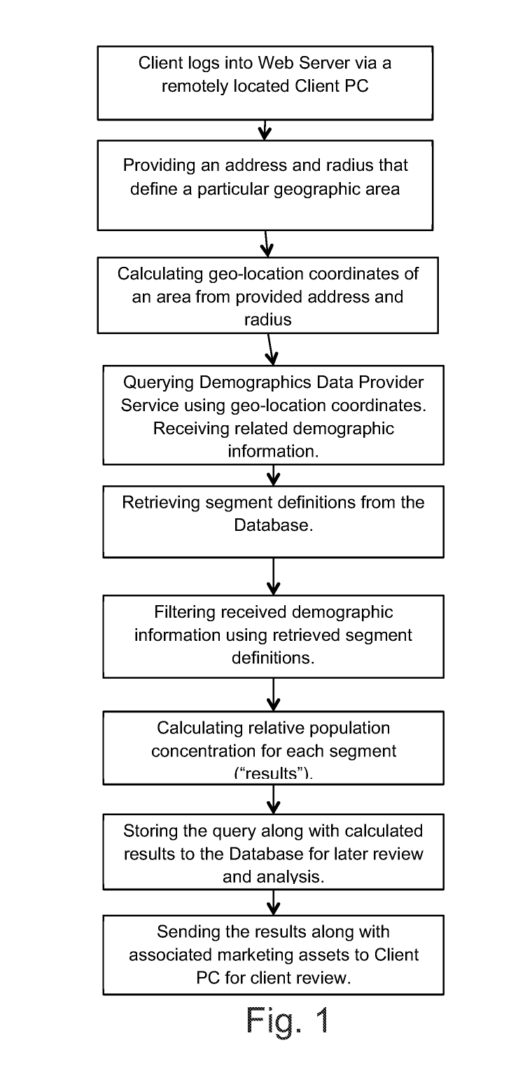

The figures represent and illustrate several features embodying a preferred demographic-based marketing system. FIG. 1 illustrates the steps taken in practicing the preferred embodiment of the present invention.

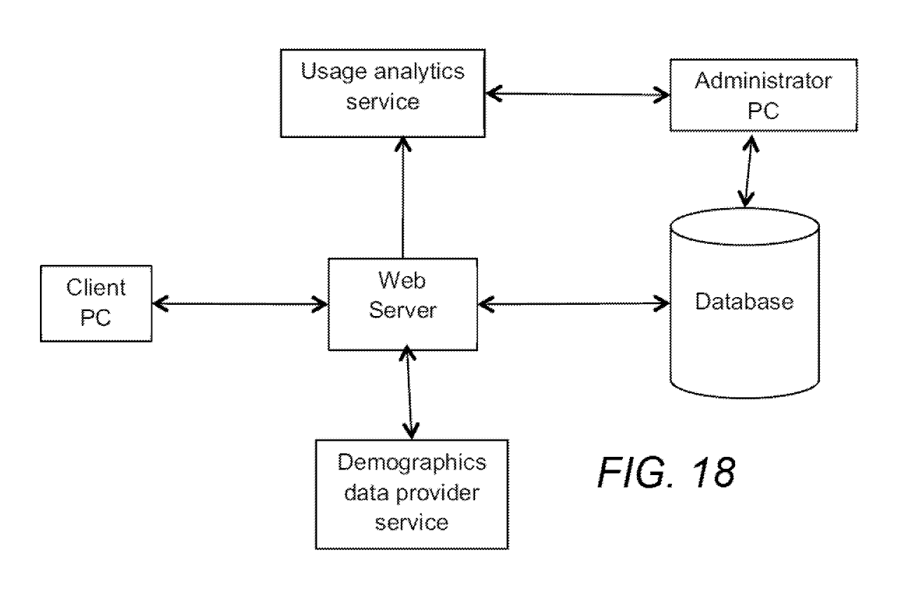

A typical marketing system as outlined in FIG. 18 would include a centralized computer database which stores the customer demographic information taken from various national databases. This information is accessible to end-users through a software interface located on their personal computing devices, such as smart phones or other mobile computing devices or basic personal computers.

End users of the present invention would likely be dealers or other business owners. They access a software tool which can utilize the database(s) of information accessible by the marketing system. In doing so, the user will perform the following steps:

First: the dealer will enter the physical location (e.g., address) of the retail location of which they desire advertising assets for. The dealer will be educated during this process about customers located within a radius (e.g., five miles) of that location.

Second: upon receiving the location information, the marketing system will filter customer data by zip code, block code, or other applied filters. The dealer will then be automatically provided with a comprehensive overview of the demographics of the customers located within the selected radius from the store location.

Third: the marketing system will guide the dealer through a process identifying a percentage of a particular customer segment which resides in a given zip code or other geographical area. As an example, this data may include age ranges or income levels. The software tool associated with the marketing system will display a brief summary of each customer segment found within an area. Other demographic information that may be relevant includes, but is not limited to, ethnicity, marital status, and parental status.

Fourth: The dealers may explore customer demographics using the software tool. The dealer may select one or more demographic segments and request additional information and education for advertising techniques to the selected customer bases.

Fifth: the dealers will then be able to view demographic information and detailed descriptions of each customer type and focus their marketing approaches on only those desirable customers in the chosen area.

The marketing system also provides dealers with at least three sets of recommendations: (1) the type of messaging or advertising that is most likely to appeal to that particular customer segment; (2) the types of products that the given customer segment is most likely to purchase; and (3) the most effective mediums to reach that type of customer. Dealers can take these recommendations and use them to build their advertising. The result is increased foot traffic to dealer stores interested in the products advertised towards those consumers.

It should be noted that the marketing system does not instruct dealers to use specific advertising assets. Rather, the system narrows the dealer's selection set of assets by guiding the dealers to a set of messages, products, and tactics that should result in a more effective and targeted advertising strategy. The system provides guidance rather than strict direction and formulaic execution. The focus is on strategy as opposed to tactics and is based upon the dealer's assets and the demographic data of customers located in the dealer's location.

FIG. 18 outlines the necessary components of a preferred marketing system. First, a client personal computer is required. This includes any computing device with a common web browser or other software which allows the computer to access internet or web server services. The client computer allows the user to access the tools associated with the marketing system, and provide the geographic location of the retail site.

The web server is a centralized computing server including a processor capable of multiple simultaneous requests from multiple clients. The web server is adapted for on-demand access to the demographics data provider service which receives demographic information from customers in desired geographic regions. The server also stores information from the various national databases discussed above. The server would also store other information and resources important to achieving the desired results, such as software applications or software tutorials for educating the client dealers.

A usage analytic service is also available which processes and stores real-time system usage information, specifically data collected from the interaction between the client's computing device and the web server.

A database is located and connected to the web server for storing segment definitions, client queries, and results. In a preferred embodiment, these segment definitions would also include a list of demographic parameters with pre-defined ranges of values.

A demographics data provider service, such as a third-party online service, may also be connected to the system. This service is adapted to receive geographic location information and return related demographic data.

An administrator computing device may also be connected to the present system. This computing device accesses database records through a similar web page interface or generic database tools. The administrator would preferably manage client login credentials and define segments using specified parameters. However, the administrator may also provide customer service or simple solution solving to client dealers.

It is to be understood that while certain embodiments and/or aspects of the invention have been shown and described, the invention is not limited thereto and encompasses various other embodiments and aspects. For example, the above embodiments discuss using demographic information as a means to develop customer segments. However, other types of data on customers could also be used, such as individual customer spending preferences, industry comparisons, or other data points.

1. A computer-implemented method of generating marketing strategies, the method comprising the steps:
associating a dealer with a personal computing device, said personal computing device including a CPU, data storage, and connection to a computer network;
registering said dealer with a marketing system, wherein said marketing system comprises a central server including a CPU, data storage containing a central database, and connection to said computer network;
populating said central database with external third-party data including at least census data;
identifying a geographical location associated with said dealer personal computing device;
calculating geographical location coordinates of a marketing area based upon said geographical location associated with said dealer personal computing device;
retrieving customer segment definitions from said database;
filtering said customer segment definitions with demographic filters;
calculating relative population concentration for each filtered customer segment and storing the results;
sending said results from said central server to said dealer personal computing device; and
generating suggested marketing suggestions based upon said results.
